(19) United States
(12) Patent Application Publication
(10) Pub. No.: US 2026/0175549 A1
(43) Pub. Date: Jun. 25, 2026

(54) OPTICAL ELEMENT WITH AN OXYGEN-IMPERMEABLE BARRIER LAYER

(71) Applicant: RODENSTOCK GMBH, Munich (DE)

(72) Inventors: Jonas BEMETZ, Munich (DE); Herbert ZINNER, Rohrbach (DE); Udo WEIGAND, Munich (DE); Uwe PISCH, Hohenkirchen (DE); Katrin DELLER, Munich (DE)

(21) Appl. No.: 18/719,604

(22) PCT Filed: Dec. 8, 2022
(86) PCT No.: PCT/EP2022/084973

§ 371 Date: Jun. 13, 2024

(30) Foreign Application Priority Data
Dec. 15, 2021 (DE) 10 2021 133 305.9

(51) Int. Cl. B32B 27/36; G02B 5/20; G02B 5/23; G02B 5/28

(52) U.S. Cl. CPC B32B 27/36; G02B 5/208; G02B 5/23; G02B 5/285

(57) ABSTRACT

The present invention relates to an optical element having a photochromic layer having improved UV stability and light stability, and to a method of producing such an optical element.

The present invention relates to an optical element having a photochromic layer having improved UV stability and light stability, and to a method of producing such an optical element.

The prior art discloses optical elements having a photochromic layer. A photochromic layer may also be referred to as a react-to-light layer. Depending on the intensity of the UV radiation incident on the optical element, the photochromic layers themselves turn light or dark, and hence so does the optical element to which they have been applied. The darkening or lightening of the photochromic layer or of the optical element is based in this case on a photochromic dye that reacts with a reversible change in shade as a result of the irradiation with UV radiation. As a result of the irradiation with UV radiation, molecular structure of the photochromic dye is altered, and hence so are the absorption characteristics thereof. If there is a decline in the irradiation with UV radiation, the photochromic dye will return to its original molecular structure and hence also its original absorption characteristics. A photochromic dye thus enables reversible switching back and forth between a dark shade and a light shade.

In general, photochromic layers having a thickness of more than 30 μm are applied to optical elements by casting or spin-coating methods, or mixed into the element by bulk methods. However, for reasons of quality, it is advantageous to apply photochromic layers having a thickness of 30 μm or less, especially having a thickness of 10 μm or less. In the case of application of photochromic layers having a thickness of 30 μm or less, especially having a thickness of 10 μm or less, it is possible to use media in which the photochromic dye is dissolved or suspended with a low viscosity. The low viscosity of such a medium leads to a constant progression of the photochromic layers and hence to improved cosmetics of the optical element.

However, photochromic layers, more specifically the photochromic dye present therein, are damaged by the action of oxygen and UV radiation. Since UV radiation is necessary for the photochromic properties of the photochromic layers, damage to the photochromic layers can be reduced only by minimizing the diffusion of oxygen into the photochromic layer.

In cases in which a photochromic layer having a thickness of more than 30 μm has been applied to an optical element, diffusion of oxygen takes place only in the upper region of the photochromic layer. The portion beneath is protected from the diffusion of oxygen and cannot be damaged by the action of oxygen and UV radiation. Photochromic layers having a thickness of more than 30 μm therefore generally have low degradation by oxygen and UV radiation.

In the case of photochromic layers having a thickness of 30 μm or less, especially of 10 μm or less, however, diffusion of oxygen takes place throughout the layer, and hence damage throughout the layer. Such photochromic layers therefore require at least a protective layer in order to protect them from degradation by oxygen and UV radiation.

Hardcoat layers that are typically applied to optical elements in order to protect them from scratches do not constitute a barrier to the diffusion of oxygen. Therefore, they cannot protect any underlying photochromic layer from degradation. Antireflection layers that may likewise be applied to optical elements in order to prevent reflections at such elements, by contrast, may reduce the diffusion of oxygen. However, these are very prone to scratches, which means that protection of the photochromic layer from oxygen diffusion may be lost at sites where the antireflection layer is damaged. The resultant local degradation of the photochromic layer is then visible as a light-colored streak in a darkened state of the optical element.

It is thus an object of the present invention to provide an optical element in which the photochromic layer is protected from degradation by oxygen and UV radiation.

This object is achieved by the embodiments of the present invention that are identified in the claims.

In particular, the invention provides an optical element comprising, in the sequence that follows, a substrate, a photochromic layer and an oxygen-impermeable barrier layer, wherein the oxygen-impermeable barrier layer comprises at least one polymer selected from the group consisting of ethylene-vinyl alcohol copolymer, cellulose hydrate, polyvinylalcohol, polyacrylonitrile, polyvinyldichloride, polyurethane and polyethylene terephthalate.

The optical element of the invention, which comprises, in the sequence that follows, a photochromic layer and an oxygen-impermeable barrier layer comprising at least one polymer selected from the group consisting of ethylene-vinyl alcohol copolymer, cellulose hydrate, polyvinylalcohol, polyacrylonitrile, polyvinyldichloride, polyurethane and polyethylene terephthalate, enables protection of the photochromic layer from degradation by oxygen and UV radiation. This can distinctly increase the lifetime of the photochromic layer and hence the lifetime of the photochromic properties of the optical element. The oxygen-impermeable barrier layer may additionally, by contrast with antireflection layers, also be disposed beneath a hardcoat lacquer, which protects it from scratches. Local damage to the oxygen-impermeable barrier layer may thus be avoided by the disposing of the oxygen-impermeable barrier layer beneath the hardcoat layer. Local damage to the oxygen-impermeable barrier layer would otherwise lead to local diffusion of oxygen into the photochromic layer and hence to damage thereof by oxygen and UV radiation. Such damage to the photochromic layer is perceived as light-colored regions in a darkened state of the optical element. Since antireflection layers cannot be disposed beneath the hardcoat layer and therefore cannot be protected from scratches or other damage, local degradation of the photochromic layer, which is readily apparent in a darkened state, can occur when antireflection layers that are prone to scratches are used as oxygen barrier. Such local degradation of the photochromic layer can be avoided by means of the oxygen-impermeable barrier layer. Moreover, the protection of the photochromic layer from degradation by oxygen and UV radiation is not based on costly antireflection layers. As a result, it is possible to equip optical elements with relatively thin photochromic layers even without an antireflection layer.

A further advantage of the optical element of the invention is that thinner photochromic layers, especially with a thickness of 30 μm or less and preferably 10 μm or less, may be provided in the optical element, and these can be applied during the production of the optical element by methods that are superior to the methods of applying thicker layers. Reasons for the superiority include reduced stockkeeping and greater flexibility based on photochromic colors, initial color and darkening depths. In addition, relatively thin photochromic layers, especially having a thickness of 30 μm or less and preferably 10 μm or less, may be produced with a lower viscosity by media in which the photochromic dye is dissolved or suspended. The lower viscosity of the medium leads to a constant profile of the photochromic layers during the application of such thin layers, and hence to improved cosmetics of the optical element. By contrast, when media having a higher viscosity are used, there is a higher risk of trapped air or an irregular profile of the photochromic layer, which can cause unsatisfactory cosmetics of the optical element via incipient streaks or waves.

There follows a detailed elucidation of the optical element of the invention, comprising, in the sequence that follows, a substrate, a photochromic layer, sometimes also referred to as photoresist, and an oxygen-impermeable barrier layer, sometimes also referred to as oxygen barrier layer.

According to the present invention, in the optical element, the substrate, the photochromic layer and the oxygen-impermeable barrier layer are in such an arrangement that, proceeding from the surface of the substrate, the photochromic layer is disposed first, and the oxygen-impermeable barrier layer is provided in a subsequent layer. The photochromic layer is therefore disposed between the substrate and the oxygen-impermeable barrier layer. In principle, at least one further layer may be disposed between the oxygen-impermeable barrier layer and the photochromic layer.

In a preferred embodiment of the present invention, the oxygen-impermeable barrier layer is disposed directly atop the photochromic layer. As a result, the photochromic layer can be better protected from the diffusion of oxygen than with additional layers in between.

The photochromic layer and the oxygen-impermeable barrier layer may be disposed on both sides or on one side of the substrate, preferably on both sides.

As well as the photochromic layer and the oxygen-impermeable layer, the optical element may comprise at least one further layer in preferred embodiments of the present invention. The possible further layers may be selected from the group consisting of primer layer, hardcoat layer, antireflection layer and cleancoat layer.

The arrangement of the further layers in the optical element is not subject to any further restriction, provided that they are suitable in principle for the optical element and the further layers can exert their function.

In a preferred embodiment, the photochromic layer has been applied directly atop the substrate.

Preferred layer structure arrangements of the optical element of the invention, proceeding from the surface of the substrate, are:
substrate/primer layer/photochromic layer/oxygen-impermeable barrier layer/hardcoat layer/antireflection layer/cleancoat layer,
substrate/primer layer/photochromic layer/oxygen-impermeable barrier layer/hardcoat layer/cleancoat layer,
substrate/photochromic layer/oxygen-impermeable barrier layer/hardcoat layer/cleancoat layer,
substrate/primer layer/photochromic layer/oxygen-impermeable barrier layer/hardcoat layer,
substrate/photochromic layer/oxygen-impermeable barrier layer/hardcoat layer/antireflection layer/cleancoat layer,
substrate/photochromic layer/oxygen-impermeable barrier layer/hardcoat layer/antireflection layer, and
substrate/photochromic layer/oxygen-impermeable barrier layer/hardcoat layer,

where the following layer arrangement is particularly preferred:
substrate/photochromic layer/oxygen-impermeable barrier layer/hardcoat layer.

Irrespective of whether the photochromic layer and the oxygen-impermeable barrier layer are disposed on both sides or on one side of the substrate, the further layers, if present, may each independently be disposed on both sides or on one side of the substrate. The primer layer, hardcoat layer and cleancoat layer are preferably disposed independently on both sides of the substrate; the antireflection layer, for reasons of cost, is preferably disposed on one side.

According to the present invention, the substrate as such is not subject to any particular restrictions, provided that it is suitable in principle for use in an optical element and is coatable with at least a photochromic layer and an oxygen-impermeable barrier layer. An optical element refers here to a component for optical apparatuses.

In relation to the base material, the substrate is not subject to any further restriction. It is thus possible for the substrate to be manufactured from mineral glass or from polymer glass. Polymer glass has the advantage over mineral glass that it has a lower density and hence a lower weight. Moreover, substrates manufactured from polymer glass have elevated breaking resistance. Examples of useful polymer materials here include polythiourethane, polyurethane, polymethylmethacrylate, polycarbonate, polyacrylate or polydiethylene glycol bisallylcarbonate, and combinations of these, although it is also possible in principle to use other transparent polymer materials.

In relation to their geometric shape, the substrate may in principle be plane-parallel, biconcave, planar-concave, convex-concave, concave-convex, planar-convex or biconvex.

In a preferred embodiment of the present invention, the optical element is a spectacle lens.

The base material of the substrate of a spectacle lens is chosen such that the spectacle lens typically has a refractive index within a range from 1.45 to 1.90, especially within a range from 1.45 to 1.55, within a range from 1.59 to 1.68 or within a range from 1.70 to 1.76. It is thus possible to use spectacle lenses made of standard glass with a refractive index of about 1.50, of quality glass having a refractive index of about 1.60 or 1.67, or of premium glass having a refractive index of about 1.74.

Typically, the front face of the substrate of a spectacle lens is of convex shape, while the reverse face toward the eye is of concave shape. In this context, the geometric shape in the case of spectacle lenses with positive refraction is referred to as concave-convex, and in the case of spectacle lenses with negative refraction as convex-concave. With regard to the geometric shape of the substrate of the spectacle lens, varifocal lenses should additionally also be mentioned. These are also referred to in the prior art as progressive lenses.

In the case of a spectacle lens, the photochromic layer and the oxygen-impermeable barrier layer are preferably disposed solely on the front side of the substrate, i.e. the side remote from the eye, in order to avoid adverse effects on the photochromic characteristics of the spectacle lens as a result of different intensities of light at different positions on the spectacle lens. In the case of a spectacle lens, the antireflection layer, if present, is preferably disposed on the front side of the substrate, i.e. the side remote from the eye.

According to the present application, the photochromic layer comprises at least one photochromic dye. Photochromic dyes are understood to mean a dye in which light (visible light or UV radiation) induces a change in absorption characteristics. Depending on the use, the person skilled in the art will choose at least one suitable photochromic dye, although the combination of multiple photochromic dyes is also possible in principle. A criterion here, as well as the actual application, is the shade to be achieved, which is to be exhibited by the optical element, for instance, in the absence or presence of light of a particular intensity.

The prior art discloses various compound classes of photochromic dyes. These are frequently benzopyrans or more highly fused ring systems thereof, chromenes, viologens, fulgides and fulgimides, and in particular also spiro compounds such as spirooxazines or spiropyrans, but without limitation thereto. Two or more of these photochromic dyes may also be combined with one another.

The photochromic layer may additionally contain a matrix comprising at least one transparent polymer material, for the photochromic dye(s) to be used. Transparent polymer materials used for the purpose are not subject to any further restriction and are known to the person skilled in the art. For example, the transparent polymer material used may be a transparent homo-or copolymer selected from the group consisting of polymethacrylates, for example poly(methylmethacrylate), poly(ethylene glycol bismethacrylate), polyacrylates, poly(ethoxylated bisphenol A dimethacrylate), thermoplastic polycarbonate, polyvinylacetate, polyvinylbutyral, polythiourethane, polyurethane or a polymer selected from the group consisting of diethylene glycol bis(allyl carbonate) monomers, diethylene glycol dimethacrylate monomers, ethoxylated phenol methacrylate monomers, ethoxylated diisopropenylbenzene monomers and ethoxylated trimethylolpropane triacrylate monomers, preferably polymethacrylates or polyacrylates.

The thickness of the photochromic layer is not subject to any further restriction, provided that the desired react-to-light properties of the optical element are achieved. In a preferred embodiment of the present invention, the thickness of the photochromic layer is at least 1 μm, preferably at least 2 μm and more preferably at least 3 μm. In addition, the thickness of the photochromic layer in the preferred embodiment is at most 60 μm, preferably at most 30 μm and more preferably at most 10 μm. The specified ranges of thickness may be freely combined here. The thickness of the photochromic layer may, for example, be 1 μm to 60 μm, preferably 2 μm to 30 μm, more preferably 3 μm to 10 μm.

Photochromic layers having a lower thickness, especially having a thickness of 30 μm or less, preferably 10 μm or less, may be applied during the production of the optical element by methods that are superior to the methods of applying thicker layers in relation to processing. Reasons for the superiority include reduced stockkeeping and greater flexibility based on photochromic colors, initial color and darkening depths.

Moreover, in the case of relatively thin photochromic layers, especially having a thickness of 30 μm or less and preferably 10 μm or less, the viscosity of the medium in which the photochromic dye is dissolved or suspended may be reduced in the method of producing the optical element. The use of media having relatively low viscosity can reduce the risk of trapped air or an irregular profile of the photochromic layer, and hence avoid adverse cosmetics of the optical element as a result of incipient streaks or waves. The thinner the photochromic layer, the lower the viscosity of the medium in which the photochromic dye is dissolved or suspended can be. Particularly for photochromic layers having a thickness of 30 μm or less, preferably 10 μm or less, it is thus possible to use a medium in which the photochromic dye is dissolved or suspended with sufficiently low viscosity in order to avoid adverse cosmetics of the optical element as a result of incipient streaks or waves.

Various methods of applying photochromic layers are known to the person skilled in the art from the prior art. Thus, the photochromic dye can be applied to the substrate as it is or embedded in a polymer material. For example, the photochromic dye can be dissolved or dispersed in a polymer material, for example by the addition of the photochromic dye to a monomeric material or prepolymer before polymerization is effected, and the polymer material containing the photochromic dye can be applied to the substrate. As well as a monomer or prepolymer to be polymerized, it is also possible to dissolve a fully polymerized polymer together with the photochromic dye. This solution is applied to the substrate and cures as a result of the evaporation of the solvent. It may be possible to additionally cure the photochromic layer by chemical crosslinking of the matrix-forming polymer materials present. The photochromic layer is preferably merely dried and not additionally chemically cured. As a result, faults that have occurred during the application, for example bubble formation, can be more easily corrected by selective removal of the layer formed. The polymer material with the embedded photochromic dye can be applied, for example, by spin-coating, dip-coating or spray-coating, but without limitation to these methods. The spin-coating method is especially suitable for application of photochromic layers having a thickness exceeding 30 μm. But thicknesses of 30 μm or less are also possible via the spin-coating method. Dip-coating is especially suitable for application of photochromic layers having a thickness of 10 μm or less. In the latter variant, it is possible to achieve a surprisingly lower tendency for the photochromic dye to migrate into other layers. This involves dipping a previously provided substrate into a dye bath. This contains a photochromic dye dissolved or dispersed in a liquid medium. The medium additionally contains a solvent and optionally a matrix-forming polymer. As a result of the dipping into the dye bath, the substrate is endowed with a film consisting of the above medium, and then pulled out of the dye bath at a particular speed. The speed at which it is pulled out of the dye bath is not subject any further restriction, provided that it is possible to apply a photochromic layer having desired properties. The speed is preferably 0.5 to 4 mm/s. As a result of evaporation of the solvent in the film that has formed on the surface of the substrate pulled out, the photochromic layer is converted to a solid form. It is optionally possible to additionally chemically cure the matrix-forming polymer present therein. Corresponding methods are sufficiently well known to the person skilled in the art. Dipping into a dye bath should be effected in such a way that the substrate provided with a photochromic layer that has been obtained after further processing has a predefined target transmittance. Transmittance also depends on the extent of dye absorption and can therefore be adjusted via the duration of immersion. As well as dipping into a dye solution, it is also possible to apply a colored paint that releases the dyes to the substrate and then to remove it again.

According to the present invention, the oxygen-impermeable barrier layer comprises at least one polymer selected from the group consisting of ethylene-vinyl alcohol copolymer, cellulose hydrate, polyvinylalcohol, polyacrylonitrile, polyvinyldichloride, polyurethane and polyethylene terephthalate. In a preferred embodiment, the oxygen-impermeable barrier layer comprises at least one polymer selected from the group consisting of ethylene-vinyl alcohol copolymer, cellulose hydrate, polyvinylalcohol, polyacrylonitrile, polyvinyldichloride and polyethylene terephthalate. The oxygen-impermeable barrier layer preferably comprises at least one polymer selected from ethylene-vinyl alcohol copolymer and polyvinylalcohol, and more preferably it comprises an ethylene-vinyl alcohol copolymer. Such polymers are capable of achieving transparent film formation. The ethylene-vinyl alcohol copolymer may have a level of hydrolysis of 92 mol % or more, 95 mol % or more, more preferably 99 mol % or more. If the oxygen-impermeable barrier layer comprises more than one polymer, all polymers, a plurality of polymers or just one polymer may have the properties specified below. The oxygen-impermeable properties of the barrier layer collectively result from the oxygen permeability of the polymer and the layer thickness of the oxygen-impermeable barrier layer. Preference is given to applying an oxygen-impermeable barrier layer with a layer thickness of below 2 μm, more preferably below 1 μm, in order not to adversely affect adhesion, cosmetics and optical properties of the optical element.

The at least one polymer preferably has an oxygen permeability of ≤0.5 mL·m·m⁻²·day⁻¹·Pa⁻¹ and more preferably of ≤0.01 mL·m·m⁻²·day⁻¹·Pa⁻¹. The oxygen permeability of the polymer is measured to ISO15105. Moreover, the at least one polymer is generally chosen such that a 4% aqueous solution thereof at 20° C. has a viscosity of 0.1 to 30 mPa·s. The viscosity of the 4% aqueous solution is measured by means of a rotary viscometer at a shear rate of 23-30 mPa·s and a temperature of 20° C.

In a preferred embodiment of the present invention, the at least one polymer has a mass-average molar mass (M_{w}) in the range from 10 000 g/mol to 130 000 g/mol, preferably 80 000 g/mol to 110 000 g/mol, determined by gel permeation chromatography (GPC) with light scattering detection to DIN EN ISO 16014-5.

As well as the at least one polymer, the oxygen-impermeable barrier layer may contain further components that improve the flow characteristics of the medium for formation of the oxygen-impermeable barrier layer during production, the adhesion of the oxygen-impermeable barrier layer to the adjoining layers of the optical element or the wetting of the oxygen-impermeable barrier layer, and bring about a smoother surface of the oxygen-impermeable barrier layer.

The layer thickness of the oxygen-impermeable barrier layer is not subject to any further restriction, provided that the diffusion of oxygen into the photochromic layer can be sufficiently prevented. In a preferred embodiment of the present invention, the oxygen-impermeable barrier layer has a layer thickness of 0.1 μm to 10 μm, preferably of 0.1 μm to 4 μm, more preferably of 0.3 μm to 2 μm. In this range of layer thickness, diffusion of oxygen into the photochromic layer is sufficiently prevented without adversely affecting the properties of the optical element.

The application of the oxygen-impermeable barrier layer is not subject to any particular restriction, provided that the oxygen-impermeable barrier layer sufficiently protects the photochromic layer from diffusion of oxygen and does not impair the properties of the optical element. Various methods suitable for the purpose are known to the person skilled in the art from the prior art. For example, the oxygen-impermeable barrier layer may be applied to the substrate by a dipping method, spraying method or spin-coating method. Such methods include the dissolving or suspending of the polymers that form the oxygen-impermeable barrier layer and of any further components in a solvent or a combination of solvents, the applying of the solution or suspension to the substrate, and the converting of the oxygen-impermeable barrier layer to a solid form by drying. Suitable solvents for sufficient suspension or dissolution of polymers that form the oxygen-impermeable barrier layer and of any further components, and suitable concentrations of the solution or suspension are known to the person skilled in the art.

In order to promote the adhesion of the layers disposed on the substrate it is possible for this purpose to provide the substrate with a primer layer. However, no primer layer is disposed on the substrate. In such an optical element, there is then no primer layer disposed between the substrate and the photochromic layer.

The primer layer, as well as increasing the bond strength of the coating, can also increase the fracture resistance of the substrate. In order to increase the bond strength between the barrier layer and other layers, it is possible for a primer layer additionally also to be disposed beneath and/or above the barrier layer. Layer thicknesses, materials and methods of applying such a primer layer are sufficiently well known to the person skilled in the art. The substrate can be provided with a primer layer, for example, by dipping methods, spraying methods or spin-coating methods.

As mentioned at the outset, it is possible to apply a hardcoat layer to the substrate in order to protect the oxygen-impermeable barrier layer from damage. This is also advisable when the substrate has been manufactured from polymer glass, since this is a comparatively soft material and hence the propensity of an optical element manufactured therefrom to be scratched is higher than in the case of mineral glass. The hardcoat layer is preferably disposed on the side of the oxygen-impermeable barrier layer remote from the photochromic layer.

The hardcoat layer may have a single-or multilayer construction. The hardcoat layer can be produced using various materials and methods that will be selected by a person skilled in the art in a suitable manner. Typically, the hardcoat layer is applied in the form of a hardcoat lacquer or of an inorganic material, especially based on quartz. However, it is preferable to use a hardcoat layer based on an acrylic polymer, a urethane polymer, a melamine polymer, a silicone resin or an inorganic material, especially based on quartz. The hardcoat layer here may be disposed over the entirety or over regions of the oxygen-impermeable layer and on one or both sides of the substrate. A hardcoat layer disposed above the oxygen-impermeable barrier layer protects the oxygen-impermeable barrier layer beneath from scratches or other mechanical damage, which maintains protection of the photochromic layer from degradation by diffusion of oxygen. A silicone resin is preferably applied as hardcoat layer to the surface of the optical element, for example proceeding from siloxanes.

A suitable layer thickness for the hardcoat layer is not subject any further restriction and can be determined directly by the person skilled in the art. The hardcoat layer preferably has a layer thickness of 20 μm or less, preferably of 1 to 15 μm and more preferably of 1 to 5 μm.

A hardcoat lacquer is generally applied by customary methods, such as a dipping method, a spraying method or a spin-coating method. If the hardcoat layer, by contrast, is an inorganic material, for instance a quartz-based material, this can be applied to the substrate by physical or chemical gas phase deposition. Methods suitable for the purpose are sufficiently well known to the person skilled in the art.

In addition, the optical element may have an antireflection layer. In one embodiment of the present invention, the optical element does not have an antireflection layer. In such cases, it is possible to obtain a less costly optical element having improved UV stability and light stability. Like the hardcoat layer, the antireflection layer may also have a single-or multilayer construction. A person skilled in the art is aware of such antireflection layers of single-or multilayer construction, without further restriction in principle of the number of layers in the case of an antireflection layer of multilayer construction. In the case of an antireflection layer of multilayer construction, the layer sequence is typically chosen such that a layer having a low refractive index of particular layer thickness is adjoined by a layer having a high refractive index of particular layer thickness. In other words, it is preferable for such a construction that layers having a low refractive index and layers having a high refractive index are in an alternating arrangement.

Corresponding materials and layer thicknesses for implementation of such a construction are known to the person skilled in the art. For instance, the antireflection layer may comprise a sequence of different transparent materials, including for example SiO₂, SiO, Ta₂O₅, TiO₂, ZrO₂, Al₂O₃, Nd₂O₅, Pr₂O₃, PrTiO₃, La₂O₃, Nb₂O₅, Y₂O₃, HfO₂, InSn oxide (ITO), Si₃N₄, MgO, MgF₂, CeO₂ and ZnS, but without limitation thereto. Some of these materials, for instance SiO₂, have a comparatively low refractive index, while others in turn, for instance Ta₂O₅, have a comparatively high refractive index.

The layer thickness of the antireflection layer having a single-or multilayer construction is not subject to any particular restriction in principle. However, it preferably has a layer thickness of 2000 nm or less, preferably 1500 nm or less and more preferably 300 nm or less. The layer thickness of the antireflection layer is simultaneously 100 nm or more. In the case of a multilayer construction of the antireflection layer, the layer thickness of each individual layer is adjusted in a suitable manner as specified above. In addition, it is possible to provide further layers in the antireflection layer, for example tie layers (for example having a layer thickness within a range from about 5 nm to 5 μm), which need not have any optical function but may be advantageous for stability, adhesion properties, climatic stability, etc.

The respective layers of the antireflection layer may be applied by dipping methods, spraying methods or spin-coating methods, and physical or chemical gas phase deposition, which are sufficiently well known to the person skilled in the art. Illustrative methods of applying by physical gas phase deposition are electron beam evaporation from a crucible, resistance evaporation from a boat, and plasma assistance during evaporation, without limitation thereto.

Thereafter, if required, a cleancoat layer, sometimes also referred to as “topcoat” or hydrophobic and/or oleophobic coating, which serves to repel soil and water droplets, may be disposed on the substrate. For instance, the cleancoat layer may preferably comprise a silane, siloxane or silazane having at least one fluorine-containing group that preferably has more than 20 carbon atoms. The silane, siloxane or silazane having at least one fluorine-containing group is preferably based on a silane, siloxane or silazane having at least one hydrolyzable group. Suitable hydrolyzable groups are not subject to any particular restriction and are known to a person skilled in the art.

The layer thickness of the cleancoat layer is not subject to any particular restriction in principle. However, it preferably has a layer thickness of 50 nm or less and preferably 20 nm or less.

The person skilled in the art is aware of corresponding materials and measures for application of such a cleancoat layer.

In a further aspect, the present invention relates to a method of producing an optical element, comprising the following steps in the following sequence:
(a) providing a substrate,
(b) applying a photochromic layer and
(c) applying an oxygen-impermeable barrier layer, preferably directly to the photochromic layer.

There follows a detailed elucidation of the production method of the invention by which the optical element of the invention can be obtained:

In the first step, first of all, a substrate is provided. As already set out in detail above, the substrate as such is not subject to any particular restrictions. The above remarks as made in this regard in connection with the optical element of the invention are correspondingly applicable to the production method of the invention.

In a subsequent step, a photochromic layer is applied to the substrate. In a preferred embodiment of the method of the invention, the photochromic layer is applied directly to the substrate. As mentioned above, the person skilled in the art is aware of the applying of photochromic layers from the prior art, and the above remarks as made in this regard for the optical element of the invention are correspondingly applicable to the step of applying photochromic layer.

In a further step, an oxygen-impermeable barrier layer is applied to the substrate.

In the step of applying an oxygen-impermeable barrier layer, the person skilled in the art is able to resort to methods known from the prior art. In a preferred embodiment of the method of the invention for producing an optical element, the step of applying the oxygen-impermeable barrier layer comprises a dipping method, spraying method or spin-coating method. Such methods may firstly comprise the dissolving or suspending of the at least one polymer that forms the oxygen-impermeable barrier layer and optionally further components in a solvent. The above remarks as made in this regard for the optical element of the invention are correspondingly applicable to the polymer that forms the oxygen-impermeable barrier layer. Subsequently, the solution or suspension is applied to the substrate in accordance with the dipping method, spraying method or spin-coating method by dipping the substrate into a bath filled with the solution or suspension and pulling it out at a speed of 0.5 to 4 mm/s, preferably 0.57 to 2 mm/s, by spraying the solution or suspension onto the substrate, or by applying the suspension or solution to the substrate and then spinning the substrate. In a spin-coating method, the substrate may be spun at a speed of 50 to 200 revolutions per minute even during the applying of the medium from which the oxygen-impermeable barrier layer is formed. After the medium has been applied, the substrate is spun for 5 to 30 seconds, preferably 10 to 20 seconds, at a speed of 200 to 700 revolutions per minute, preferably 300 to 600 revolutions per minute, more preferably 400 to 500 revolutions per minute. The oxygen-impermeable layer is preferably applied by dipping methods or spin-coating methods.

The oxygen-impermeable barrier layer is subsequently converted to a solid form by removing the solvent of the solution or suspension applied to the substrate, for example by drying or evaporation of the solvent. The drying can be conducted at room temperature to 200° C., preferably 40° C. to 150° C. and more preferably at 60° C. to 90° C. It is known to the person skilled in the art that the duration of drying depends on the temperature and the boiling point of the solvent. For example, the drying can be conducted for 2 to 25 minutes, preferably 5 to 10 minutes.

If further layers are provided in the optical element to be produced, the method of the invention for production in the corresponding sequence may be supplemented by the corresponding steps of applying the further layers. Among the layers that may optionally be applied additionally in such a way are a hardcoat layer, an antireflection layer and/or a cleancoat layer. As mentioned above, the hardcoat layer and the antireflection layer, if provided, may be applied by dipping methods, spraying methods or spin-coating methods, or by physical or chemical gas phase deposition. The substrate may additionally be provided with a primer layer beforehand. Here too, the above remarks as made in this regard for the optical element of the invention are correspondingly applicable.

In a further aspect, the present application relates to the use of an optical element. The above-described optical element of the invention can be used as such or as a component of an optical apparatus of any type and form for a multitude of end uses for which photochromic characteristics are important. In particular, the optical element may be used for ophthalmic purposes, as lenses for all kinds of spectacles, such as sunglasses, protective goggles, ski goggles, visors for helmets and for sunscreen purposes in vehicles and in the construction sector, in the form of windows, protective shades, covers, roofs and the like.

### DESCRIPTION OF FIGURES

FIG. 1 shows the degradation characteristics of the photochromic layer of an optical element comprising an oxygen-impermeable barrier layer that has been applied by spin-coating, by comparison with a photochromic layer of an optical element that does not comprise an oxygen-impermeable barrier layer, after accelerated aging by irradiation with a xenon lamp, where neither optical element includes an additional hardcoat layer.

FIG. 2 shows the different degradation of a photochromic layer in optical elements with and without an oxygen-impermeable barrier layer applied by a dipping method after accelerated aging by irradiation with a xenon lamp, where both optical elements additionally include a hardcoat layer.

### EXAMPLES

The examples that follow serve to elucidate the present invention, but without limitation thereto.

In a first illustrative embodiment, an optical element having an oxygen-impermeable barrier layer and an identical element without an oxygen-impermeable barrier layer are produced as follows:

A substrate consisting of a thermally crosslinked acrylate polymer in the form of a planar disk having a thickness of 3 mm, a diameter of 60 mm and an optical refractive index of 1.5 is provided. The substrate comprises a photochromic layer disposed thereon and having a thickness of 5 μm. The photochromic layer contains a photochromic dye and an acrylate polymer. The photochromic layer was applied as a solution with 1-methoxy-2-propanol as solvent and cured by drying. An oxygen-impermeable barrier layer is applied by spin-coating using an aqueous 5% ethylene-vinyl alcohol copolymer solution having an n-propanol: water mixture in a ratio of 3:7. This involves applying 1 mL of the solution to the substrate, which is spun at a speed of rotation of 100 revolutions per minute. The ethylene-vinyl alcohol copolymer used has a degree of hydrolysis of 99-99.4 mol %. Subsequently, the substrate is spun at a speed of rotation of 450 revolutions per minute for a further 12 seconds. Subsequently, the film applied is dried at 90° C. for 5 minutes, and the oxygen-impermeable barrier layer is obtained in solid form with a layer thickness of 1.7 μm.

In a second illustrative execution, an optical element with an oxygen-impermeable barrier layer and a hardcoat layer, and an identical element without an oxygen-impermeable barrier layer are produced as follows:

A substrate consisting of polythiourethane in the form of an active lens having a thickness of 2 mm, a diameter of 60 mm, an optical refractive index of 1.6 and a refraction of −2.25 dpt is provided. A photochromic layer having a thickness of 7 μm is disposed on the substrate. The photochromic layer contains a photochromic dye and an acrylate polymer. The photochromic layer was applied by spin-coating as a solution in 1-methoxy-2-propanol as solvent and cured by drying. The substrate is immersed into a tank containing an aqueous 2.5% ethylene-vinyl alcohol copolymer solution based on a n-propanol:water mixture in a ratio of 3:7, and pulled out at a speed of 1 mm/s. The ethylene-vinyl alcohol copolymer has a degree of hydrolysis of 99-99.4 mol %. Subsequently, the film applied is dried for 10 minutes at 60° C., which gives the oxygen-impermeable barrier layer in solid form. After cooling, the substrate is immersed into a hardcoat layer-forming solution containing water, methanol, ethanol, isopropanol and 1-methoxypropanol as solvents, and pulled out at a speed of 1 mm/s. By pre-drying at 60° C. for 10 minutes and then curing at 110° C. for 3 hours, a hardcoat layer is formed on the substrate. The hardcoat layer is a polysiloxane-based thermally cured layer.

The resultant optical elements are subjected to accelerated aging by irradiation with a xenon lamp without any additional monitoring or influencing of the temperature and examined for degradation of the photochromic layer after 25 and 50 hours (xenon test). The xenon lamp has an emission spectrum similar to sunlight. The distance between the optical elements and the xenon lamp is calibrated such that the optical elements are exposed to irradiation with a power of 700 W/m². The distance is kept constant throughout the aging process.

The degradation of the photochromic layer of the optical elements with and without an oxygen-impermeable layer is assessed by visual assessment in the light and darkened state of the optical element. The darkened state of the optical element is achieved by irradiation with a solar simulator at an effective power incident on the optical element of 4 mW/cm² for the emission of radiation in the UVA region over 0.5 minute. In the darkened state, an optical element having an undamaged photochromic layer has overall transmittance of 10%, while it has overall transmittance of 86% in the undarkened state. Overall transmittance is measured in accordance with DIN EN ISO 8980-3.

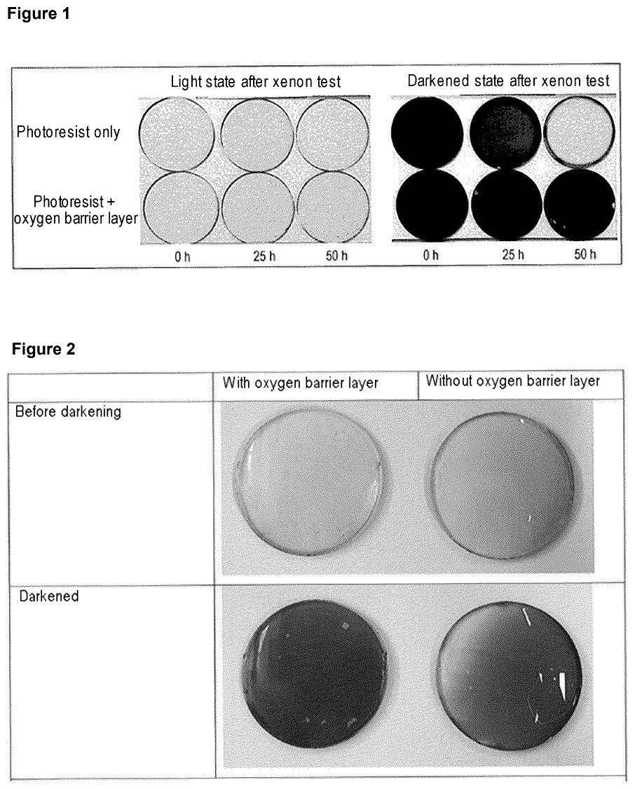

As can be inferred from FIG. 1, distinct darkening can be detected after accelerated aging over 50 hours by a xenon lamp for the optical element with an oxygen-impermeable layer and without an additional hardcoat layer. The photochromic layer can be protected from degradation by oxygen and UV radiation by the oxygen-impermeable barrier layer. The optical element retains its photochromic properties. For instance, in transmittance measurements on the optical element with an oxygen-impermeable layer, no increase in overall transmittance can be found after accelerated aging for 25 hours.

For the corresponding optical element without an oxygen-impermeable barrier layer, by contrast, no darkening of the photochromic layer can be detected after accelerated aging for 50 hours under identical conditions. Complete degradation of the photochromic layer occurs over the course of 50 hours, and the element loses its photochromic properties completely. Moreover, after accelerated ageing for 25 hours, an increase in overall transmittance from 10% to 21% can be established.

It can be inferred from FIG. 2 for optical elements that further include a hardcoat layer that the optical element without an oxygen-impermeable barrier layer, after accelerated aging for 50 hours in the non-darkened state, has worsened optical properties that are visually apparent by the distinct yellowing of the element. Yellowing cannot be observed in the corresponding optical element with an oxygen-impermeable barrier layer in the non-darkened state after accelerated aging for 50 hours.

It can be inferred from the comparison of the two photochromic elements that have been subjected to accelerated aging for 50 hours that the degradation of the photochromic layer in an optical element of the invention can be avoided by the applying of an oxygen-impermeable barrier layer, and the lifetime of the photochromic layer or of the photochromic properties of the optical element of the invention can be extended.

1. An optical element comprising, in the sequence that follows, a substrate, a photochromic layer and an oxygen-impermeable barrier layer, wherein the oxygen-impermeable barrier layer comprises at least one polymer selected from the group consisting of ethylene-vinyl alcohol copolymer, cellulose hydrate, polyvinylalcohol, polyacrylonitrile, polyvinyldichloride, polyurethane and polyethylene terephthalate.

2. The optical element as claimed in claim 1, wherein the photochromic layer is disposed directly atop the substrate.

3. The optical element of claim 1, wherein the at least one polymer is selected from the group consisting of ethylene-vinyl alcohol copolymer, cellulose hydrate, polyvinylalcohol, polyacrylonitrile, polyvinyldichloride and polyethylene terephthalate.

4. The optical element of claim 1, wherein the oxygen-impermeable barrier layer is disposed directly atop the photochromic layer.

5. The optical element of claim 1, wherein the photochromic layer has a thickness of 30 μm or less, preferably 10 μm or less.

6. The optical element of claim 1, wherein the layer thickness of the oxygen-impermeable layer is 0.1 μm to 10 μm.

7. The optical element of claim 1, wherein the at least one polymer has a mass-average molar mass (M_{w}) of 10 000 g/mol to 130 000 g/mol.

8. The optical element of claim 1, wherein the optical element further comprises at least one layer selected from a hardcoat layer and an antireflection layer, disposed on the side of the oxygen-impermeable barrier layer remote from the photochromic layer.

9. The optical element of claim 1, wherein the optical element is a spectacle lens.

10. A method of producing an optical element, comprising the following steps in the following sequence:
(a) providing a substrate,
(b) applying a photochromic layer and
(c) applying an oxygen-impermeable barrier layer, preferably directly to the photochromic layer.

11. The method as claimed in claim 10, wherein the photochromic layer is applied directly to the substrate.

12. An optical system comprising the optical element of claim 1 selected from lenses for all kinds of spectacles, such as sunglasses, protective goggles, visors for helmets, for sunscreen purposes in vehicles, and in the construction sector, in the form of windows, protective shades, covers, and roofs.
